(19) United States
(12) Patent Application Publication
(10) Pub. No.: US 2019/0035300 A1
(43) Pub. Date: Jan. 31, 2019

(54) METHOD AND APPARATUS FOR MEASURING ORAL READING RATE

(71) Applicant: Analytic Measures Inc., Palo Alto, CA (US)

(72) Inventor: Jared C. Bernstein, Palo Alto, CA (US)

(21) Appl. No.: 16/048,130

(22) Filed: Jul. 27, 2018

Related U.S. Application Data
(60) Provisional application No. 62/538,204, filed on Jul. 28, 2017.

(51) Int. Cl. G09B 17/04; G10L 15/26; G10L 15/197

(52) U.S. Cl. CPC G09B 17/04; G10L 15/197; G10L 15/265

(57) ABSTRACT

A method and apparatus for measuring oral reading rate are described. Oral reading rate represents how fast a reader can decipher printed text and correctly speak the written words. The rate can be a representation of speed only, or in the case of accurate oral reading rate, it can measure the rate of oral reading for only words read correctly. In the method described, a passage of text is subdivided into units. The duration of speaking each unit is measured and these durations are mapped to values that are used in a polytomous probabilistic model. Through a series of steps using this model, a new value of each reader's reading rate called the Unified Reading Rate (URR) is estimated. An apparatus that measures the URR using the above method is also described. This apparatus is software that runs on one or more computational devices and includes a speech recognition engine as well as other components that produce the URR.

### RELATED APPLICATIONS

This application is a non-provisional patent application of and claims priority to U.S. Provisional Application No. 62/538,204, filed 28 Jul. 2017, which is incorporated by reference herein.

### FIELD OF THE INVENTION

The present invention concerns methods and apparatus for measuring oral reading rates, representing how fast a reader can decipher printed text and correctly speak written words.

### BACKGROUND

An important focus of education in the early grades is teaching the skill of reading. One approach to evaluating a student's reading ability is to have the student read aloud and subsequently analyze his or her reading performance. A great deal of information can be extracted from oral readings, including analysis of misread words and of pacing and adherence to punctuation. Because oral reading provides a window into the process of reading as opposed to just the product (e.g., comprehension as measured by answers to questions), oral reading has been the focus of many reading assessments in education. But even though oral reading has been prominent in assessment, there are many opportunities for improving the current state-of-the-art.

Rate is a measure of how fast a person reads and usually represents the rate of accurate reading (as opposed to a measure that counted skipped words or words read incorrectly from the source text). Traditionally, rate has been measured as words correct per minute (WCPM), which is computed by timing a student reading appropriate grade-level material. WCPM is simply a tally of the number of words the student read correctly during a one-minute interval.

In existing reading assessments that have focused on reading rate (for example, DIBELS, AIMSWEB, and ReadNaturally), the material presented to students is at grade level. Thus, younger students are presented with easier passages than older students. Unfortunately, this confounds rate with text level and presents some problems for the measurement of reading rate. Many researchers including Hasbrouck and Tindal (2006) have provided norm charts showing reading rate percentiles for each grade level at different times during the school year (fall, winter, and spring). A pattern in these norm charts is that reading rate increases throughout the year, but then drops in the fall of the next grade. One factor that might contribute to this drop is skill atrophy in which the summer break slows reading practice and therefore reading progress. However, another factor is the difficulty of the reading material presented in the test; the difficulty of the passages increases as the grade level increases. With the current measures of reading rate, these two factors of reading ability and passage difficulty are confounded.

Moreover, from a practical standpoint, a great deal of time and money is invested in standardizing passages used as test materials. In order to ensure that students are exposed to passages that are strictly targeted to a specific grade level, test publishers may develop a large number of passages for the purpose of vetting and then collect readings from hundreds or thousands of students. Such extensive empirical trials are required to select passages that result in similar reading times for a specific grade. In practice, this leveling process and the practice of only presenting grade-leveled passages for assessment may diminish the precision of reading rate measures, especially for struggling readers who might benefit from easier material on high-interest topics. Furthermore, even with extensive data collection and careful passage selection, there are always residual differences in average or expected reading times.

Together, these issues highlight the need for improvements in the field.

### SUMMARY OF THE INVENTION

In accordance with one embodiment of the invention, a passage of text is subdivided into units (e.g., sentences, phrases, words, syllables, morphemes and/or phones). The duration of speaking each unit is measured and these durations are mapped to values that are used in a polytomous probabilistic model. Through a series of steps using this model, a new value of each reader's reading rate called the Unified Reading Rate (URR) is estimated. An apparatus that measures URR using the above method is also described. This apparatus is software that runs on one or more computational devices and includes a speech recognition engine as well as other components that produce URR.

These and other embodiments of the invention are more fully described in association with the drawings below.

### BRIEF DESCRIPTION OF THE DRAWINGS

FIG. 1 depicts a flowchart of a process to generate an estimate of a reader's unified reading rate (URR), in accordance with one embodiment of the invention.

FIG. 2 depicts a block diagram of a system to generate an estimate of a reader's URR, in accordance with one embodiment of the invention.

FIG. 3 depicts components of a computer system in which computer readable instructions instantiating the methods of the present invention may be stored and executed.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. Descriptions associated with any one of the figures may be applied to different figures containing like or similar components/steps. While the sequence diagrams each present a series of steps in a certain order, the order of some of the steps may be changed.

In various embodiments, the present invention provides methods and apparatus for determining a new measure of oral reading rate referred to herein as the Unified Reading Rate (URR). The URR represents how fast a reader can decipher printed text and correctly speak written words. The rate can be a representation of speed only, or in the case of accurate oral reading rate, it can measure the rate of oral reading for only words read correctly. In the method described, a passage of text is subdivided into units. The duration of speaking each unit is measured and these durations are mapped to values that are used in a polytomous probabilistic model. Through a series of steps using this model, a new value of each reader's reading rate called the URR is estimated. An apparatus that measures URR using the above method is also described. This apparatus may be software that runs on one or more computational devices and includes a speech recognition engine as well as other components that produce URR.

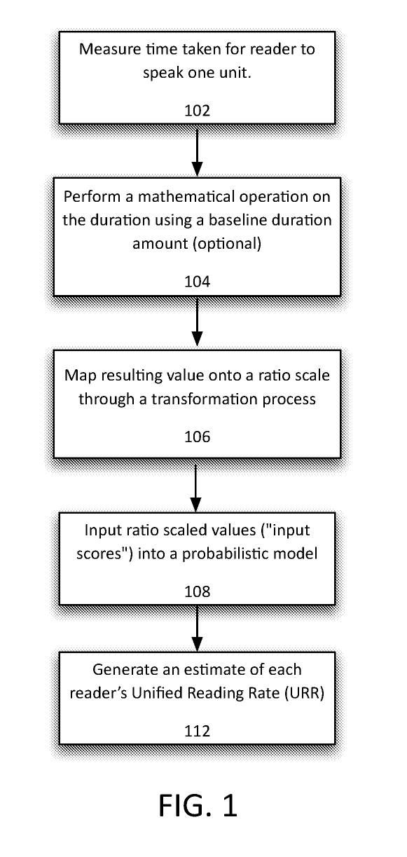

The method is based on the idea that a passage can be broken down into units smaller than the passage itself, such as but not limited to sentences, phrases, words, syllables, morphemes and/or phones, each with onset and offset rules. For example, the unit of a word can be defined as the offset of speaking the previous word up to the offset of speaking the current word. As shown in FIG. 1, the time it takes the reader to speak one unit is measured (102). An optional next step is to perform a mathematical operation on the duration using a baseline duration amount (104). This baseline duration could be an estimate of the duration it would take representative good readers or speakers to say this unit. The mathematical operation could be but is not limited to subtracting the baseline from the duration, computing a ratio of the duration over the baseline value, or taking the log of the ratio. The resulting value is mapped onto a ratio scale through a transformation process (106). The method of this transformation could include computing a mathematical operation or performing steps of an algorithm, and/or a combination of these. The scale might be, but is not limited to the values 0 to 10. Other scales will work as well. These values, which are now on a ratio scale, are called input scores and will be input into a probabilistic model (108) to generate an estimate of each reader's URR (112).

The probabilistic model is based on the logistic function. It takes input scores as input and produces two kinds of estimates. The first is the difficulty value of each unit. For example, a unit such as the word “nonchalant” will have a higher difficulty value compared to the difficulty value for a unit that has a more transparent spelling or that appears more frequently in the language and is therefore easier to read, such as “important.” The difficulty estimate also includes estimates of how much more difficult it is for a reader to have an input score of 2 versus 3 for a given unit or 7 versus 8. A difficulty value is associated and estimated for each of these steps from one input score to another. Finally, an estimate is generated for each reader's URR.

The probabilistic model can be represented by any item response theory (IRT) equations or Rasch model equations that uses a rating scale or partial credit model (Andrich, 1978; Masters, 1982; Muraki, 1997; Samejima, 2016). While the use probabilistic models for answering comprehension questions based on reading text have been described (Donoghue, 1994), original to the present invention is the application of either a rating scale or partial credit probabilistic model to the measurement of reading rate. Moreover, whereas the use of a probabilistic model for reading rate as a dichotomous measure, where performance above a median is considered correct and at or below the median is considered incorrect (Powell-Smith, Good, & Atkins, 2010), unique to the current invention is the application of a polytomous scoring approach (a rating scale or partial credit model) to create a new measure of reading rate, the URR.

In one embodiment, the steps for deriving each reader's URR are as follows: Compute a seed estimate of a reader's URR value. Use this seed estimate to compute initial estimates of each unit's difficulty value. The estimates are computed from IRT or Rasch mathematical models with polytomous scoring and apply a maximum likelihood estimation procedure (e.g. joint maximum likelihood estimation (JMLE) or conditional maximum likelihood estimation (CMLE) to name just a few) such that the estimates are the most likely values given the probabilistic model. Using an iterative process, the estimates are adjusted and refined until the model converges. The model converges if the difference between the current estimates (n) and the estimates from the previous iteration (n−1) are below some threshold value. An appropriate difference threshold for accepting convergence can be based on common practice. When unit difficulties are already estimated, a reader's URR can be generated using the same process with unit difficulty values held constant.

The estimates are then mapped onto a scale with desired attributes. The process for mapping the estimates onto a scale might include but is not limited to a mathematical transform. The final values are URRs for each reader.

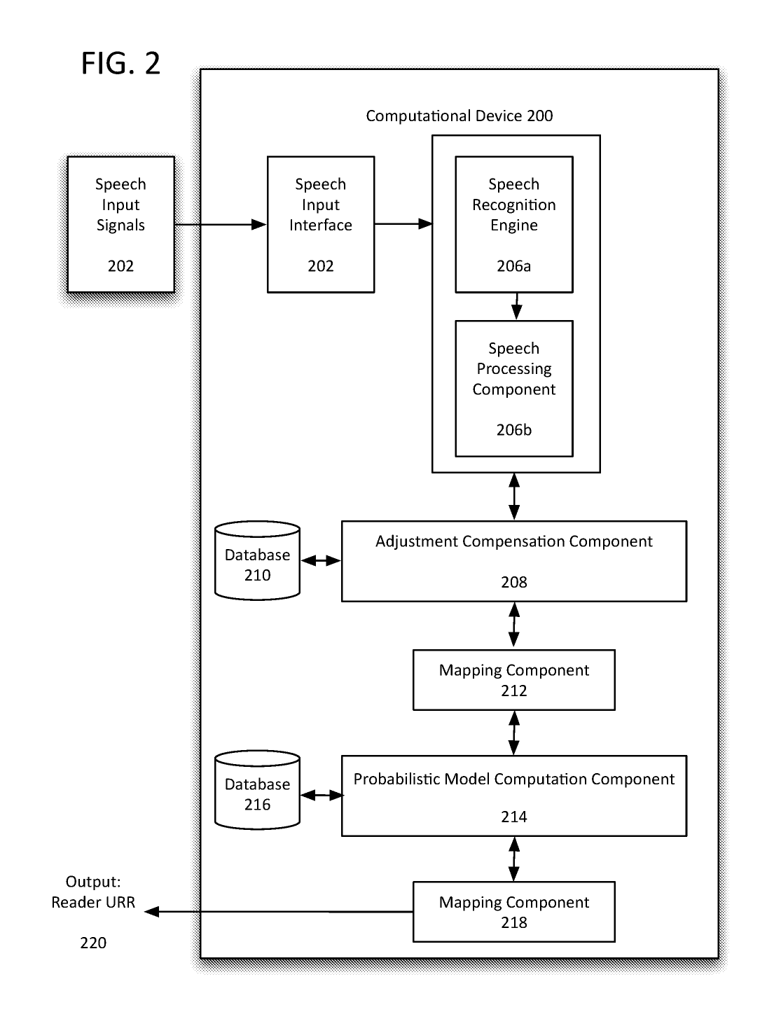

The apparatus for measuring oral reading rate is, in one embodiment, a computational device 200, as shown in FIG. 2. The apparatus accepts speech signals as input (202) via a speech input interface (204). The received speech signal are then applied as inputs to a speech recognition engine (206a) and speech processing component (206b) for automatically determining the words that the reader said and automatically measuring the time it took the reader to say each unit. This information is passed to Adjustment Computation Component (208) for adjusting duration values. This Adjustment Computation Component has access to a database (210) of baseline durations for reading aloud or saying units. Each duration may be modified in some way that considers the baseline duration. The adjusted duration is then passed to a mapping component (212) where the duration is mapped onto a value on a ratio scale. This value is passed to the next component, the Probabilistic Model Computation Component (214). This component might have access to a database (216) of parameters that have already been estimated, for example the numeric difficulties of some of the units. The output values of the Probabilistic Model Computation Component are passed to another mapping component (218) where the values are mapped to a scale with appropriate attributes. The resulting values are each reader's Unified Reading Rate (220). The above-described apparatus may be an appropriately configured computing system, with software instantiating the above-described components stored in a memory and executed by a computer processor.

The invention has many practical applications. For example, URRs can be used to determine which students need reading intervention instruction and how much improvement has been observed without the added confound of passage difficulty. The concept of measuring duration of reading smaller units within each passage allows for more effective passage leveling using equating methods common to IRT but never before available for oral reading fluency passages. Further, analysis of durations of smaller units lends itself to more in-depth analyses of reading behavior and text characteristics within the passage as reading is taking place. For example, it yields a rate and an estimate of the reliability of that rate.

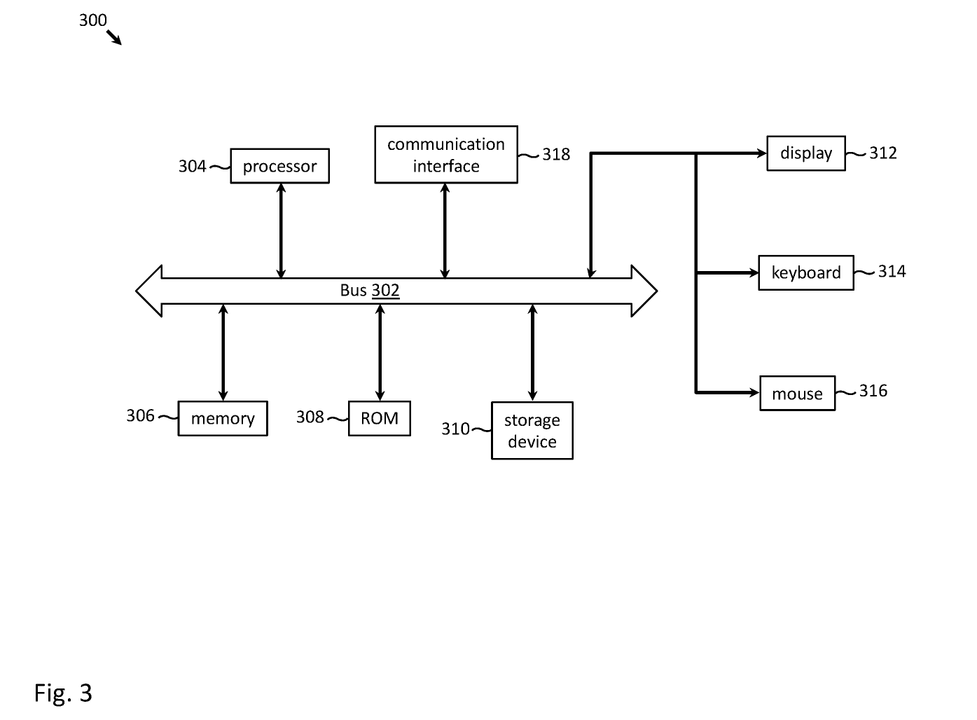

As is apparent from the foregoing discussion, aspects of the present invention involve the use of various computer systems and computer readable storage media having computer-readable instructions stored thereon. FIG. 3 provides an example of a system 300 that may be representative of any of the computing systems (e.g., computational device 200) discussed herein. Examples of system 300 may include a smartphone, a desktop, a laptop, a mainframe computer, an embedded system, etc. Note, not all of the various computer systems have all of the features of system 300. For example, certain ones of the computer systems discussed above may not include a display inasmuch as the display function may be provided by a client computer communicatively coupled to the computer system or a display function may be unnecessary. Such details are not critical to the present invention.

System 300 includes a bus 302 or other communication mechanism for communicating information, and a processor 304 coupled with the bus 302 for processing information. Computer system 300 also includes a main memory 306, such as a random access memory (RAM) or other dynamic storage device, coupled to the bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to the bus 302 for storing static information and instructions for the processor 304. A storage device 310, for example a hard disk, flash memory-based storage medium, or other storage medium from which processor 304 can read, is provided and coupled to the bus 302 for storing information and instructions (e.g., operating systems, applications programs and the like).

Computer system 300 may be coupled via the bus 302 to a display 312, such as a flat panel display, for displaying information to a computer user. An input device 314, such as a keyboard including alphanumeric and other keys, may be coupled to the bus 302 for communicating information and command selections to the processor 304. Another type of user input device is cursor control device 316, such as a mouse, a trackpad, or similar input device for communicating direction information and command selections to processor 304 and for controlling cursor movement on the display 312. Other user interface devices, such as microphones, speakers, etc. are not shown in detail but may be involved with the receipt of user input and/or presentation of output.

The processes referred to herein may be implemented by processor 304 executing appropriate sequences of computer-readable instructions contained in main memory 306. Such instructions may be read into main memory 306 from another computer-readable medium, such as storage device 310, and execution of the sequences of instructions contained in the main memory 306 causes the processor 304 to perform the associated actions. In alternative embodiments, hard-wired circuitry or firmware-controlled processing units may be used in place of or in combination with processor 304 and its associated computer software instructions to implement the invention. The computer-readable instructions may be rendered in any computer language.

In general, all of the above process descriptions are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying”, “receiving”, “transmitting” or the like, refer to the action and processes of an appropriately programmed computer system, such as computer system 300 or similar electronic computing device, that manipulates and transforms data represented as physical (electronic) quantities within its registers and memories into other data similarly represented as physical quantities within its memories or registers or other such information storage, transmission or display devices.

Computer system 300 also includes a communication interface 318 coupled to the bus 302. Communication interface 318 may provide a two-way data communication channel with a computer network, which provides connectivity to and among the various computer systems discussed above. For example, communication interface 318 may be a local area network (LAN) card to provide a data communication connection to a compatible LAN, which itself is communicatively coupled to the Internet through one or more Internet service provider networks. The precise details of such communication paths are not critical to the present invention. What is important is that computer system 300 can send and receive messages and data through the communication interface 318 and in that way communicate with hosts accessible via the Internet. It is noted that the components of system 300 may be located in a single device or located in a plurality of physically and/or geographically distributed devices.

Thus, a method and apparatus for measuring oral reading rate has been described. It is to be understood that the above-description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A method, comprising:
measuring one or more durations it takes a reader to speak one or more units of a passage of text presented to the reader;
performing a mathematical operation that adjusts the measured one or more durations using one or more baseline duration values that are estimates of durations it would take representative good readers to say the one or more units;
mapping the adjusted values onto a scale through a transformation process;
using the mapped adjusted value as input scores to a probabilistic model; and
generating an estimate of the reader's unified reading rate using the probabilistic model.

2. An apparatus for measuring oral reading rate, comprising:
a speech input interface configured to accept speech signals and apply the speech signals as inputs to a speech recognition engine and speech processing component for automatically determining text units that a reader spoke, and automatically measuring a duration it took the reader to speak each of the text units;
an adjustment computation component for receiving and adjusting the measured durations, the adjustment computation component having access to a database of baseline durations for reading aloud or speaking the text units, and the adjustment computation component modifying the measured durations so as to give consideration to the baseline durations;
a first mapping component for receiving the adjusted durations and mapping the adjusted durations as values on a first scale; and
a probabilistic model computation component coupled to receive the values on the first scale and having access to a database of parameters that have already been estimated, the probabilistic model computation component outputting a result to a second mapping component configured to map said result to a second scale, wherein the result expressed in the second scale is output as the reader's unified reading rate.
